(19) United States
(12) Patent Application Publication
(10) Pub. No.: US 2012/0225586 A1
(43) Pub. Date: Sep. 6, 2012

(54) ELECTRICAL CONNECTOR

(75) Inventors: Shang Ju Tsai, Keelung (TW); Yan Xian Yuan, Guangzhou (CN); Yao Li, Guangzhou (CN)

(73) Assignee: LOTES CO., LTD., Keelung (TW)

(21) Appl. No.: 13/272,972

(22) Filed: Oct. 13, 2011

(30) Foreign Application Priority Data
Mar. 4, 2011 (CN) 201120056275.9

(51) Int. Cl. H01R 24/00

(52) U.S. Cl. 439/626

(57) ABSTRACT

An electrical connector is used for electrically connecting a chip module and includes: an insulating body, having a plurality of receiving slots; and a plurality of terminals, disposed in the receiving slots and each having a base plate, a contact arm and at least one extending arm, in which the base plate is fixed in the receiving slot, the contact arm is located on one side of the base plate and has a contact portion conducting the chip module, the contact portion is higher than the base plate and is exposed outside the receiving slot, and the extending arm is in a bent shape and has a lower end connected to the contact arm and an upper end connected to the base plate.

### CROSS-REFERENCE TO RELATED APPLICATION

This non-provisional application claims priority under 35 U.S.C. §119(a) on Patent Application No. 201120056275.9 filed in China on Mar. 4, 2011, the entire contents of which are hereby incorporated by reference.

### FIELD OF THE INVENTION

The present invention relates to an electrical connector, and more particularly to an electrical connector for electrically connecting a chip module to a circuit board.

### BACKGROUND OF THE INVENTION

Generally, an electrical connector is used to connect a chip module to a circuit board in this industry nowadays. Conductive terminals in the electrical connector are generally formed by directly punching a metal plate (e.g. a copper material) or punching and bending a metal plate. For example, Chinese Patent No. CN02255032.1 discloses a terminal which has a positioning board. The positioning board is provided with a recess, a connecting board is obliquely bent and extends downwards from a bottom of the recess, and further a contact board is obliquely bent and extends upwards from the connecting board. The contact board is provided with a contact portion. The contact portion is higher than the positioning board and is configured to contact the chip module. The terminal is assembled in the body of the electrical connector and is fixed and positioned by two sides of the positioning board. The total length of the contact board and the connecting board is referred to as an arm of force.

However, the above structure still has the following deficiencies.

1. When the metal plate is punched to form the terminals, as the connecting board is directly connected to the positioning board, and the contact board is formed by bending a tail end of the connecting board, the expanding length of the terminal is long and a long plate is needed for punching to obtain a long enough arm of force so as to ensure the elasticity of the arm of force, which causes a waste of material and increases the cost.

2. When the electrical connector is installed on the circuit board and the chip module is installed on the electrical connector, a conductive portion of the chip module is in contact with the contact portion correspondingly. A connection point of the contact board and the connecting board forms a contact point for contacting a conductive portion of the circuit board correspondingly. To achieve a stable conduction of the chip module, the electrical connector and the circuit board, one end of the terminal needs to bear a down pressure of the chip module and the other end needs to bear a counter thrust of the circuit board. That is to say, when the chip module presses the contact portion of the terminal downwards, the contact portion is in the trend of moving forwards and the arm of force is flipped in a moving direction of the contact portion by taking the connection point of the connecting board and the positioning board as the deformation point, and meanwhile the contact point is driven to move upwards. Even if the contact point moves upwards and is in the trend of disengaging from the circuit board, the contact point can still be guaranteed to contact the circuit board. This contact between the contact point and the circuit board is a hard interference, which results in that the down pressure of the chip module is concentrated at the contact point and the arm of force of the connecting board cannot be utilized, so that the arm of force that bears the down pressure of the chip module easily gets fatigue. Therefore, the terminal is not durable and the elasticity of the arm of force is unsatisfactory.

Therefore, a heretofore unaddressed need exists in the art to address the aforementioned deficiencies and inadequacies.

### SUMMARY OF THE INVENTION

In one aspect, the present invention is directed to an electrical connector which can save the material and eliminate the problem of terminal fatigue.

In one embodiment, the present invention provides an electrical connector. The electrical connector is used for electrically connecting a chip module and includes: an insulating body, having a plurality of receiving slots; and a plurality of terminals, correspondingly disposed in the receiving slots and each having a base plate, a contact arm and at least one extending arm, in which the base plate is fixed in the receiving slot, the contact arm is located on one side of the base plate and has a contact portion conducting the chip module, the contact portion is higher than the base plate and is exposed outside the receiving slot, and the extending arm is in a bent shape and has a lower end connected to the contact arm and an upper end connected to the base plate. A position where the extending arm and the base plate are connected is defined as a first fulcrum, a position where the extending arm and the contact arm are connected is defined as a second fulcrum, and the second fulcrum is higher than the lowest point of the extending arm. When the chip module presses the contact portion downwards, the extending arm deforms downwards at the first fulcrum, and meanwhile the contact arm and the extending arm rotate to be deviated relatively in a direction away from the base plate at the second fulcrum.

As compared with the related art, the terminal of the electrical connector of the present invention includes the base plate and the contact arm located on one side of the base plate. The lower end of the extending arm is connected to the contact arm, and the upper end of the extending arm is connected to the base plate, so that when the terminal is expanded, a part of the contact arm is located in the same plane and has the same length as the extending arm. Therefore, as compared with the related art, a short metal plate can be punched to provide a long enough arm of force. When the chip module presses the contact portion downwards, the extending arm deforms downwards at the first fulcrum, and meanwhile the contact arm and the extending arm rotate to be deviated relatively in a direction away from the base plate at the second fulcrum, thereby alleviating the problem of terminal fatigue through the simultaneous movement at the first fulcrum and the second fulcrum.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIG. 1 is a schematic view of a terminal of an electrical connector according to one embodiment of the present invention before bending;

FIG. 2 is a three-dimensional view of a terminal of the electrical connector according to one embodiment of the present invention after being shaped;

FIG. 3 is a side view of the terminal in FIG. 2;

FIG. 4 is an exploded view of a terminal of the electrical connector according to one embodiment of the present invention assembled in an insulating body and connected to a solder ball;

FIG. 5 is a sectional view of the insulating body in FIG. 4;

FIG. 6 is a sectional view of a terminal of the electrical connector according to one embodiment of the present invention installed in an insulating body, having one side connected to a solder ball and with a chip module installed thereon;

FIG. 7 is a schematic view of deformation of the extending arm downwards at the first fulcrum when the chip module in FIG. 6 presses the terminal downwards; and

FIG. 8 is a schematic view of rotation of the contact arm and the extending arm to be deviated relatively in a direction away from the base plate at the second fulcrum when the chip module in FIG. 6 presses the terminal downwards.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

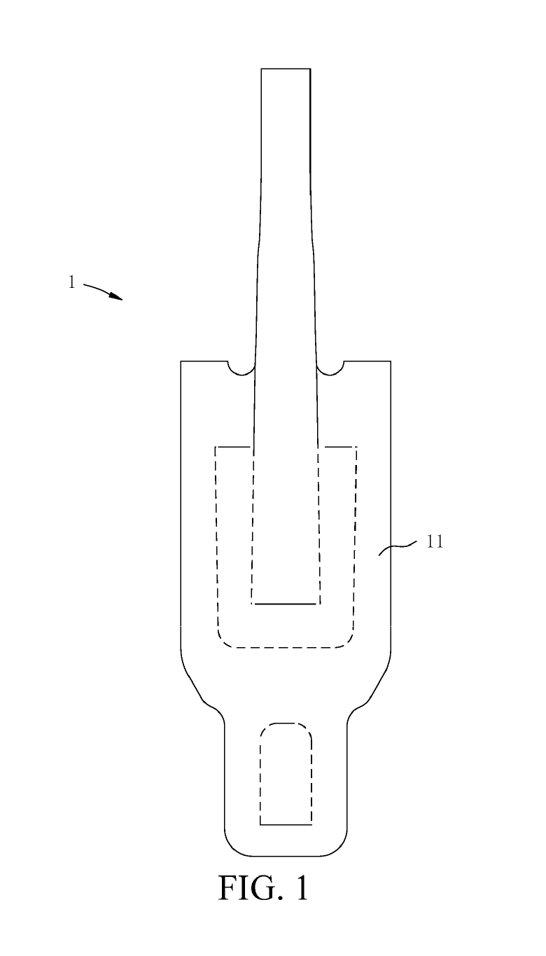

Referring to FIG. 1, the electrical connector of the present invention is used for electrically connecting a chip module 4 to a circuit board (not shown). Terminals 1 of the electrical connector are formed by punching and then bending a metal plate material, and before punching, the terminal 1 as a whole is located in the same plane. It should be particularly noted that two sides of the terminal 1 in a width direction are defined to be “side” (e.g. the left and right directions in FIG. 1) and two sides of the terminal 1 in a length direction are defined to be “end” (e.g. the up and down directions in FIG. 1). Furthermore, the number of the extending arm 14 described below may be one or more, and in this embodiment the number of the extending arm 14 is two for illustration.

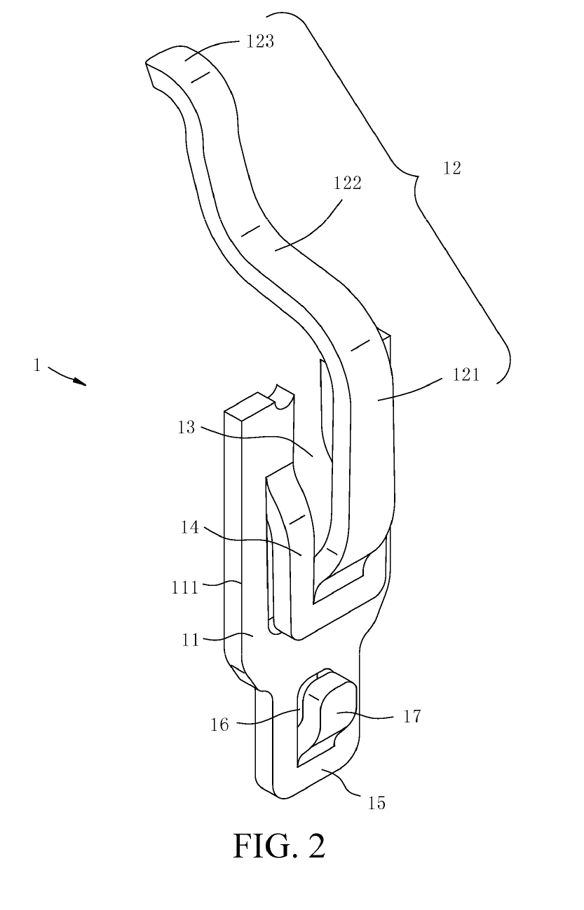

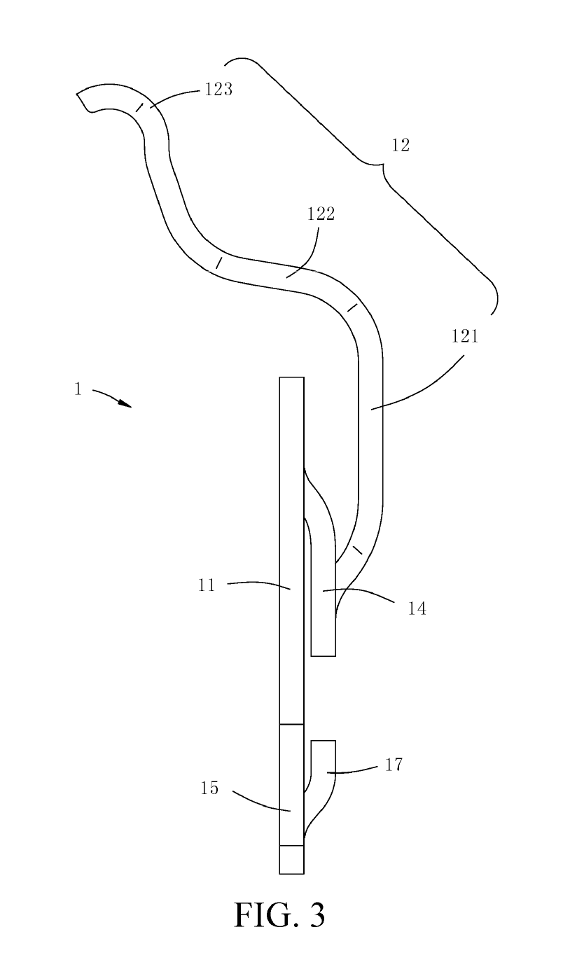

Referring to FIGS. 2 and 3, the terminal 1 has a base plate 11 and a contact arm 12 located on one side of the base plate 11. The base plate 11 is opened with a notch 13. The base plate 11 on two sides of the notch 13 is defined as a fixing portion 111 for providing a fixing function.

The notch 13 has an open upper end. A first connecting portion (not marked) is respectively disposed between the upper end of the notch 13 and the two fixing portions 111. Lower ends of the two first connecting portions respectively extend downwards to form an extending arm 14. Lower ends of the two extending arms 14 are connected and a second connecting portion (not marked) is formed therebetween. An upper end of the second connecting portion extends upwards to form the contact arm 12. The contact arm 12 is located between the two extending arms 14, and the two extending arms 14 and the contact arm 12 are connected to form a unity. The two extending arms 14 are in a bent shape, so that the lowest point of the two extending arms 14 is not lower than a lower inner edge of the notch 13. That is to say, the straightened length of the two extending arms 14 is equal to the height of the notch 13. The extending arms 14 may be bent once or multiple times. The two extending arms 14 are located out of the notch 13 (alternatively, in other embodiments, the two extending arms 14 may be located in the notch 13) and are located between the two fixing portions 111. In this embodiment, the two extending arms 14 are formed by piecing the base plate 11 and are bent relative to the base plate 11.

The two extending arms 14 are disposed symmetrically. The so-called symmetry refers to that the two extending arms 14 have the same height, width and length. In this manner, when the terminal 1 suffers a down pressure of the chip module 4, the contact arm 12 stays in a stable balanced state.

Alternatively, in other embodiments, one end of the extending arm 14 (i.e. the end connected to the notch 13) may also be connected to the upper end of the fixing portion 111.

The contact arm 12 is partially formed by piecing the base plate 11 and is relatively deviated from the base plate 11, so that an upper end of the base plate 11 forms a slit, i.e. the slit is formed between the two first connecting portions. The split is in communication with the notch 13. The slit separates the upper end of the base plate 11 into left and right parts, i.e. the two extending arms 14 are located on two sides of the slit. The width of the contact arm 12 is equal to a distance between the two extending arms 14. The contact arm 12 includes a first connecting arm 121 and a second connecting arm 122. The first connecting arm 121 has a lower end connected to the extending arm 14, and is formed by firstly bending and then extending in a direction away from the base plate 11 and in the same direction as the plane where the base plate 11 is located (i.e. the first connecting arm 121 is parallel to the base plate 11, and alternatively, in other embodiments, the contact arm 12 may be firstly bent and then extend in a direction away from the base plate 11 and upwards obliquely to form the first connecting arm 121). The second connecting arm 122 is bent from a tail end of the first connecting arm 121 and extends upwards obliquely in a direction towards the base plate 11. A tail end of the second connecting arm 122 is bent to form a contact portion 123 for conducting the chip module 4. The contact portion 123 is higher than the base plate 11. The tail end of the second connecting arm 122 may also be not bent, and the tail end of the second connecting arm 122 directly contacts the chip module 4. Therefore, the contact arm 12 may be formed by bending and extending at least twice. The first connecting arm 121 and the two extending arms 14 are located on the same side of the base plate 11 (alternatively, in other embodiments, the first connecting arm 121 and the two extending arms 14 may also be respectively located on two sides of the base plate 11), and the extending arm 14 is located between the first connecting arm 121 and the base plate 11.

The terminal 1 includes the base plate 11 and the contact arm 12 located on one side of the base plate 11. The lower end of the extending arm 14 is connected to the contact arm 12, and the upper end of the extending arm 14 is connected to the base plate 11, so that when the terminal 1 is expanded, the first connecting arm 121 (i.e. a part of the contact arm 12) is located in the same plane and has the same length as the extending arm 14. Therefore, as compared with the related art, a short metal plate can be punched to provide a long enough arm of force (the arm of force is the total length of the contact arm 12 and the extending arm 14), thus saving the material and reducing the cost.

The base plate 11 extends downwards to form a soldering portion 15, and the soldering portion 15 is located in the same plane as the base plate 11. The width of the soldering portion 15 is smaller than the width of the base plate 11. The soldering portion 15 is provided with an opening 16, and a clip portion 17 extends upwards from a lower inner edge of the opening 16. The clip portion 17 is formed by piecing the soldering portion 15, and the width of the clip portion 17 is equal to the width of the opening 16. The clip portion 17 and the extending arm 14 may be located on the same side of the base plate 11 or located on different sides of the base plate 11.

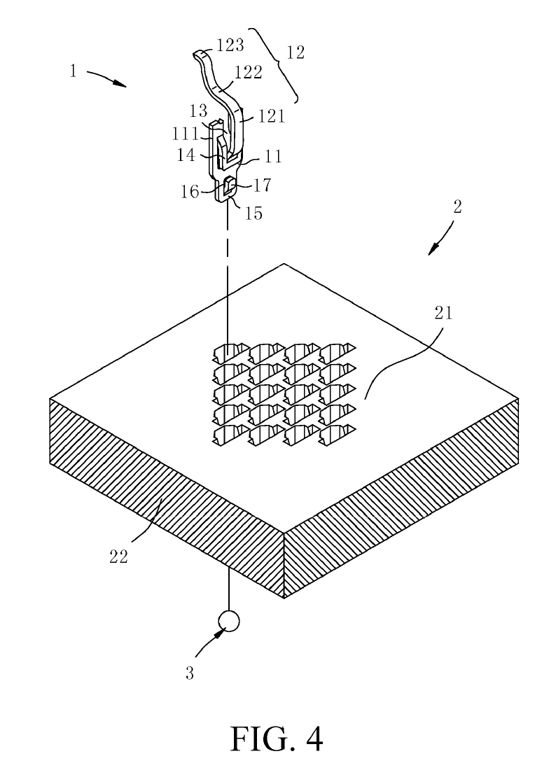

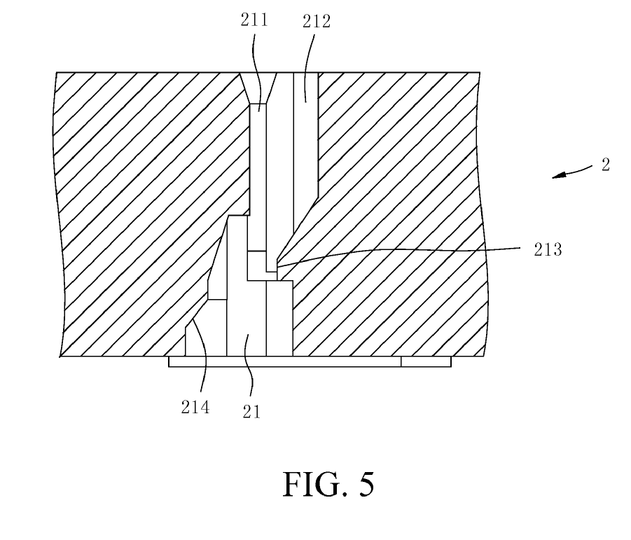

Referring to FIGS. 4 to 6, the electrical connector of the present invention is formed by the above terminals 1 and an insulating body 2. The insulating body 2 has a plurality of receiving slots 21 arranged in rows, and each row of the receiving slots 21 is parallel to a side wall 22 of the insulating body 2. The receiving slots 21 in a front row and the receiving slots 21 in a back row are arranged in a staggered manner. As disclosed in the figures, one receiving slot 21 in the back row is located between two neighboring receiving slots 21 in the front row. This structure allows high density arrangement of the terminals 1 in the receiving slots 21, so as to achieve a multifunctional effect.

The receiving slot 21 is provided with two opposite fixing slots 211 for correspondingly retaining and fixing the fixing portions 111 on two sides of the base plate 11. An upper end of the receiving slot 21 is recessed with a reserved slot 212 corresponding to the first connecting arm 121, for accommodating the first connecting arm 121 and providing a space for elastic deformation of the first connecting arm 121. The second connecting arm 122 and the contact portion 123 protrude above the receiving slot 21 and may be in contact with the chip module 4. One inner side wall of the receiving slot 21 is provided with a protruding stop block 213 corresponding to the clip portion 17. The stop block 213 is located above the clip portion 17 to stop the upward movement of the clip portion 17, so that the terminal 1 is stably fixed in the receiving slot 21. The receiving slot 21 has an accommodating space 214 recessed from the lower end thereof for accommodating a solder ball 3. One side of the solder ball 3 urges against the soldering portion 15 and the other side of the solder ball 3 urges against a side wall of the accommodating space 214. The soldering portion 15 protrudes below the receiving slot 21, so as to solder the terminal 1 to the circuit board. It should be particularly noted that the layout inside the receiving slot 21 is not limited to that disclosed in the figures of this embodiment and may be arranged according to the structure of the terminal 1. A portion of the terminal 1 close to the soldering portion 15 may be used as a positioning portion, so that the fixing portion 111 may also be used as a part of the arm of force for bearing the down pressure of the chip module 4, thereby increasing the length and elasticity of the arm of force.

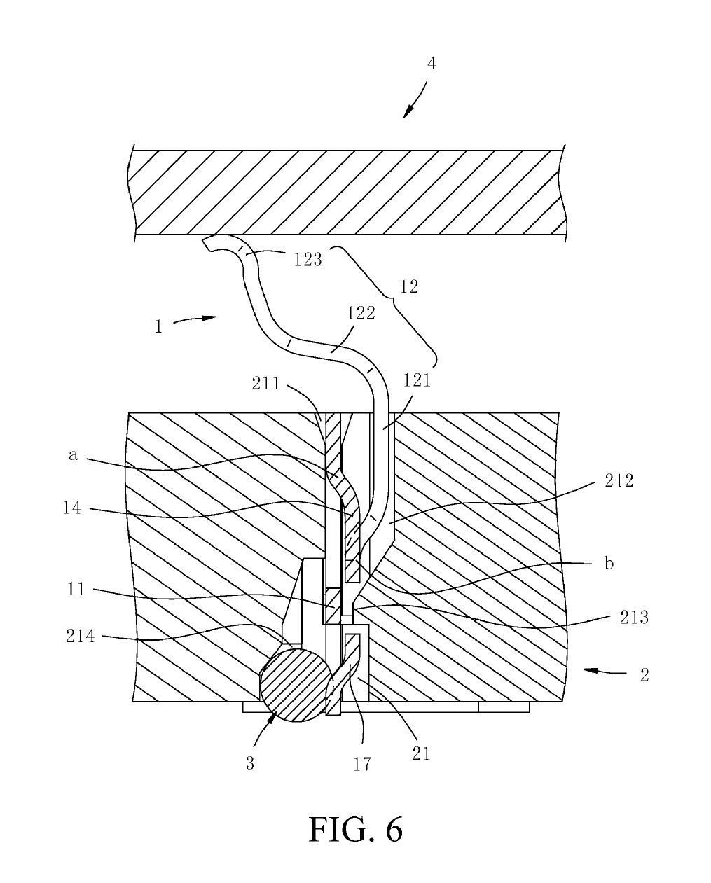

During assembly, referring to FIGS. 4 and 6, the terminals 1 are installed in the corresponding receiving slots 21 one by one from the top of the insulating body 2, so that the clip portion 17 gets into the position below the stop block 213 after being across the stop block 213 and is stopped by the stop block 213, the fixing portions 111 on two sides of the base plate 11 are engaged into the corresponding fixing slots 211 and the second connecting arm 122 and the contact portion 123 are exposed above the insulating body 2, the first connecting arm 121 is located in the reserved slot 212, and the soldering portion 15 protrudes below the insulating body 2. Thus, the assembly of the electrical connector is completed.

FIGS. 6 to 8 are schematic views of movement of the electrical connector of the present invention when suffering a down pressure of the chip module 4. A position where the extending arm 14 and the base plate 11 are connected is defined as a first fulcrum a, a position where the extending arm 14 and the contact arm 12 are connected is defined as a second fulcrum b, and the second fulcrum b is higher than the lowest point of the extending arm 14, so that when the terminal 1 suffers the down pressure of the chip module 4, the first fulcrum a and the second fulcrum b both function.

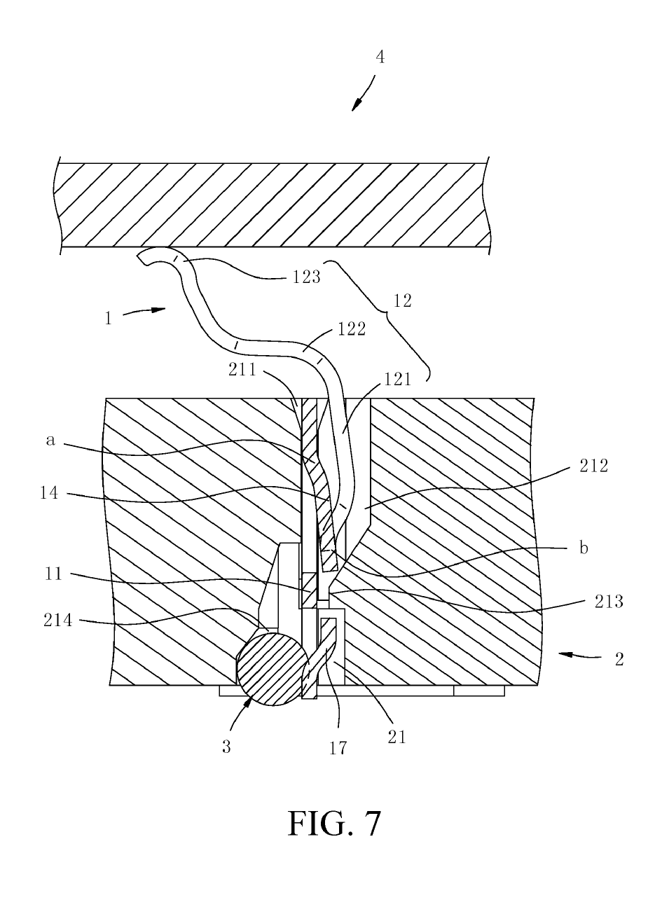

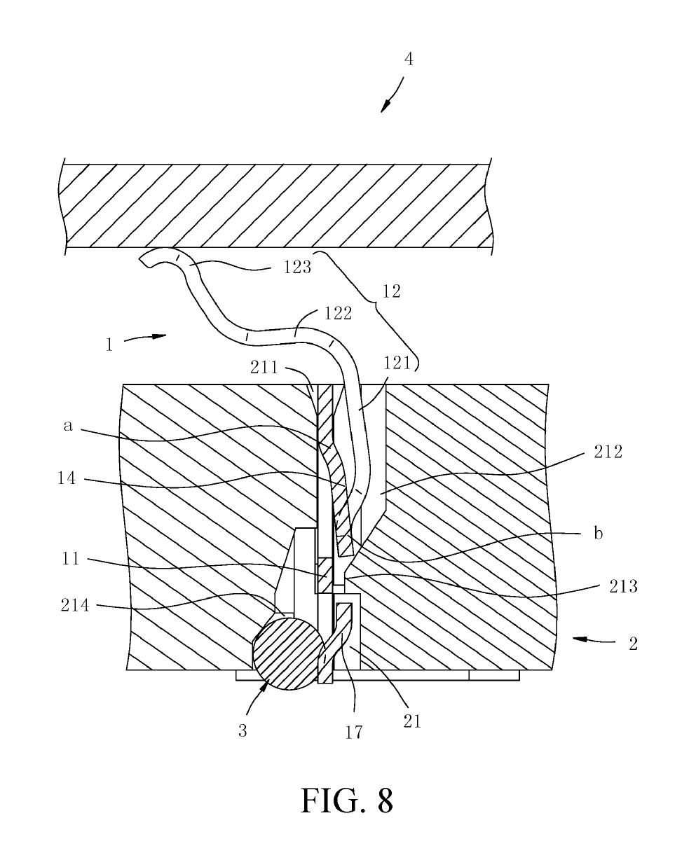

The soldering portion 15 of the electrical connector is soldered on the circuit board through the solder ball 3, and the chip module 4 is further connected to the electrical connector in a compressed contact manner. Therefore, when the chip module 4 presses the terminal 1 downwards, a certain force is exerted on the terminal 1. At this time, as the two extending arms 14 are in a bent shape, the extending arm 14 deforms downwards at the first fulcrum a (as shown in FIG. 7), and meanwhile the contact arm 12 and the extending arm 14 rotate to be deviated relatively in a direction away from the base plate 11 at the second fulcrum b (as shown in FIG. 8), so that the down pressure suffered by the contact arm 12 is partially transferred to the two extending arms 14 through the deformation at the second fulcrum b, and the problem of terminal fatigue in the related art is alleviated through the simultaneous movement at the first fulcrum a and the second fulcrum b, thus increasing the durability of the terminal 1. The down pressure suffered by the contact arm 12 is partially transferred to the two extending arms 14 through the second fulcrum b, so the contact arm 12 and the extending arm 14 are both utilized. Therefore, the elasticity of the terminal 1 is better than that of the related art.

Based on the above, the electrical connector of the present invention, among other things, has the following beneficial effects.

1. The terminal includes the base plate and the contact arm located on one side of the base plate. The lower end of the extending arm is connected to the contact arm, and the upper end of the extending arm is connected to the base plate, so that when the terminal is expanded, a part of the contact arm is located in the same plane and has the same length as the extending arm. Therefore, a short metal plate can be punched to provide a long enough arm of force, thus saving the material and reducing the cost.

2. When the chip module presses the terminal downwards, a certain force is exerted on the terminal. At this time, as the two extending arms are in a bent shape, the extending arm extends downwards to deform at the first fulcrum, and the contact arm and the extending arm rotate to be deviated relatively in a direction away from the base plate at the second fulcrum. The down pressure suffered by the contact arm is partially transferred to the two extending arms through the deformation at the second fulcrum, and the problem of terminal fatigue in the related art is alleviated through the simultaneous movement at the first fulcrum and the second fulcrum, thus increasing the durability of the terminal.

3. When the chip module presses the terminal downwards, a certain force is exerted on the terminals, the down pressure suffered by the contact arm is partially transferred to the two extending arms through the second fulcrum, so the contact arm and the extending arm are both utilized, Therefore, the elasticity of the terminal is better than that of the related art.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connector, for electrically connecting a chip module, comprising:
(a) an insulating body, having a plurality of receiving slots; and
(b) a plurality of terminals, correspondingly disposed in the receiving slots and each having a base plate, a contact arm and at least one extending arm, wherein the base plate is fixed in the receiving slot, the contact arm is located on one side of the base plate and has a contact portion conducting the chip module, the contact portion is higher than the base plate and is exposed outside the receiving slot, and the extending arm is in a bent shape and has a lower end connected to the contact arm and an upper end connected to the base plate;
wherein a position where the extending arm and the base plate are connected is defined as a first fulcrum, a position where the extending arm and the contact arm are connected is defined as a second fulcrum, and the second fulcrum is higher than the lowest point of the extending arm; and
when the chip module presses the contact portion downwards, the extending arm deforms downwards at the first fulcrum, and meanwhile the contact arm and the extending arm rotate to be deviated relatively in a direction away from the base plate at the second fulcrum.

2. The electrical connector according to claim 1, wherein the base plate is provided with a notch and the extending arm extends downwards from one end of the notch.

3. The electrical connector according to claim 2, wherein there are two extending arms extending from the notch and the contact arm is connected between the two extending arms.

4. The electrical connector according to claim 3, wherein the two extending arms are disposed symmetrically.

5. The electrical connector according to claim 3, wherein the width of the contact arm is equal to a distance between the two extending arms.

6. The electrical connector according to claim 2, wherein a straightened length of the extending arm is equal to a height of the notch.

7. The electrical connector according to claim 2, wherein the extending arm is located in the notch.

8. The electrical connector according to claim 2, wherein the extending arm is located out of the notch.

9. The electrical connector according to claim 1, wherein the contact arm is formed by bending at least twice, and the contact arm comprises a first connecting arm and a second connecting arm extending from the first connecting arm.

10. The electrical connector according to claim 9, wherein the contact arm is firstly bent and then extends in the same direction as the plane where the base plate is located to form the first connecting arm.

11. The electrical connector according to claim 9, wherein the contact arm is firstly bent and then extends in a direction away from the base plate and upwards obliquely to form the first connecting arm.

12. The electrical connector according to claim 9, wherein the first connecting arm and the extending arm are respectively located on two sides of the base plate.

13. The electrical connector according to claim 9, wherein the first connecting arm and the extending arm are located on the same side of the base plate.

14. The electrical connector according to claim 1, wherein the base plate extends downwards to form a soldering portion, the soldering portion is provided with an opening, a clip portion extends upwards from an inner side of the opening, one inner side wall of the receiving slot is provided with a protruding stop block corresponding to the clip portion, and the stop block is located right above the clip portion.

15. The electrical connector according to claim 1, wherein a plurality of receiving slots in a row and a plurality of receiving slots in an adjacent row are arranged in a staggered manner.

16. The electrical connector according to claim 1, wherein two sides of the base plate are provided with two fixing portions and the receiving slot is provided with two fixing slots for correspondingly retaining the fixing portions.

17. The electrical connector according to claim 1, wherein the contact arm is further bent to form the contact portion.
